(19) United States
(12) Patent Application Publication
(10) Pub. No.: US 2023/0316460 A1
(43) Pub. Date: Oct. 5, 2023

(54) BINOCULAR IMAGE QUICK PROCESSING METHOD AND APPARATUS AND CORRESPONDING STORAGE MEDIUM

(71) Applicant: KANDAO TECHNOLOGY CO., LTD., Shenzhen (CN)

(72) Inventors: Dan CHEN, Shenzhen (CN); Zhigang TAN, Shenzhen (CN); Yuyao ZHANG, Shenzhen (CN)

(73) Assignee: KANDAO TECHNOLOGY CO., LTD., Shenzhen (CN)

(21) Appl. No.: 18/041,800

(22) PCT Filed: Apr. 19, 2021
(86) PCT No.: PCT/CN2021/088003

§ 371 Date: Feb. 16, 2023

(30) Foreign Application Priority Data
May 29, 2020 (CN) 202010471421.8

(51) Int. Cl. G06T 3/40; G06T 5/50; G06T 7/33

(52) U.S. Cl. CPC G06T 3/4046; G06T 5/50; G06T 7/33; G06T 2207/20084; G06T 2207/20221; G06T 2207/10012

(57) ABSTRACT

The present invention provides a binocular image quick processing method, including: performing feature extraction on a next-level left eye image and a next-level right eye image; acquiring a next-level image phase difference distribution estimation feature; fusing the next-level image phase difference distribution estimation feature and a next-level left eye image feature to obtain a next-level fusion feature; performing feature extraction on the next-level fusion feature to obtain a difference feature of next-level left and right eye images, and obtain an estimated phase difference of the next-level left and right eye images; acquiring an estimated phase difference of first-level left and right eye images; and performing processing operation on the corresponding images by using the estimated phase difference of the first-level left and right eye images.

### TECHNICAL FIELD

The present invention relates to the technical field of image processing, in particular to a binocular image quick processing method and apparatus and a corresponding storage medium.

### BACKGROUND

Due to existence of disparity in binocular vision, images formed between monocles have displacement. For example, in a horizontal transverse direction, displacement of a pixel of one picture in a monocular image relative to a corresponding pixel of the other picture is a horizontal visual phase difference of binocular visual images.

Sizes of objects in existing binocular visual images may be different, which leads to a larger difference in feature precision of object features corresponding to objects of different sizes when analyzing image features, thus leading to a larger difference of an acquired binocular visual image phase difference. The accuracy of the binocular visual image phase difference is also lower, which makes it impossible to effectively process the corresponding images.

Therefore, it is necessary to provide a binocular image quick processing method and apparatus to solve problems existing in the prior art.

### SUMMARY

Embodiments of the present invention provide a binocular image quick processing method and apparatus that can quickly and accurately acquire a binocular visual image difference, to solve the technical problems of a larger difference and lower accuracy of the binocular visual image phase difference acquired by an existing binocular image quick processing method and apparatus.

An embodiment of the present invention provides a binocular image quick processing method, including:
acquiring a first-level left eye image and a corresponding first-level right eye image;
performing folding dimensionality reduction operation on the first-level left eye image to acquire at least one next-level left eye image corresponding to the first-level left eye image, and performing the folding dimensionality reduction operation on the first-level right eye image to acquire at least one next-level right eye image corresponding to the first-level right eye image;
performing feature extraction on the next-level left eye image by using a first preset residual convolutional network to obtain a next-level left eye image feature, and performing feature extraction on the next-level right eye image by using the first preset residual convolutional network to obtain a next-level right eye image feature;
performing phase difference distribution estimation on the next-level left eye image feature and the next-level right eye image feature to obtain a corresponding next-level image phase difference distribution estimation feature;
fusing the next-level image phase difference distribution estimation feature with the next-level left eye image feature to obtain a next-level fusion feature;
performing feature extraction on the next-level fusion feature by using a second preset residual convolutional network to obtain a difference feature of next-level left and right eye images;
obtaining an estimated phase difference of the next-level left and right eye images based on the difference feature of the next-level left and right eye images;
performing tiling dimensionality raising operation on the difference feature to obtain a corrected difference feature of first-level left and right eye images, and performing the tiling dimensionality raising operation on the estimated phase difference to obtain a corrected phase difference of the first-level left and right eye images;
obtaining an estimated phase difference of the first-level left and right eye images according to first-level left and right eye feature data, the corrected difference feature of the first-level left and right eye images, and the corrected phase difference of the first-level left and right eye images; and
performing image processing operation on the corresponding images by using the estimated phase difference of the first-level left and right eye images.

An embodiment of the present invention further provides a binocular image quick processing apparatus, including:
an image acquiring module, configured to acquire a first-level left eye image and a corresponding first-level right eye image;
a folding dimensionality reduction module, configured to perform folding dimensionality reduction operation on the first-level left eye image to acquire at least one next-level left eye image corresponding to the first-level left eye image, and perform the folding dimensionality reduction operation on the first-level right eye image to acquire at least one next-level right eye image corresponding to the first-level right eye image;
a first feature extraction module, configured to perform feature extraction on the next-level left eye image by using a first preset residual convolutional network to obtain a next-level left eye image feature, and perform the feature extraction on the next-level right eye image by using the first preset residual convolutional network to obtain a next-level right eye image feature;
a phase difference distribution estimation module, configured to perform phase difference distribution estimation on the next-level left eye image feature and the next-level right eye image feature to obtain a corresponding next-level image phase difference distribution estimation feature;
a fusing module, configured to fuse the next-level image phase difference distribution estimation feature with the next-level left eye image feature to obtain a next-level fusion feature;
a second feature extraction module, configured to perform feature extraction on the next-level fusion feature by using a second preset residual convolutional network to obtain a difference feature of next-level left and right eye images;
a next-level estimated phase difference acquiring module, configured to obtain an estimated phase difference of the next-level left and right eye images based on the difference feature of the next-level left and right eye images;
a tiling dimensionality raising module, configured to perform tiling dimensionality raising operation on the difference feature to obtain a corrected difference feature of first-level left and right eye images, and perform the tiling dimensionality raising operation on the estimated phase difference to obtain a corrected phase difference of the first-level left and right eye images;
a previous-level estimated phase difference acquiring module, configured to obtain an estimated phase difference of the first-level left and right eye images according to first-level left and right eye feature data, the corrected difference feature of the first-level left and right eye images, and the corrected phase difference of the first-level left and right eye images; and
an image processing module, configured to perform image processing operation on the corresponding images by using the estimated phase difference of the first-level left and right eye images.

An embodiment of the present invention further provides a computer readable storage medium, in which a processor executable instruction is stored. The instruction is loaded by one or more processors to execute any of the above binocular image quick processing methods.

Compared with a binocular image quick processing method and apparatus of the prior art, the binocular image quick processing method and apparatus of the present invention can acquire the difference features of the first-level left eye image and the first-level right eye image in different dimensions and the corresponding estimated phase differences through the next-level left eye images and next-level right eye images of the plurality of different dimensions, so that the estimated phase difference of the first-level left and right eye images can be quickly and accurately acquired, thereby improving a corresponding image processing efficiency; and the technical problems of a larger difference and lower accuracy of a binocular visual image phase difference acquired by the existing binocular image quick processing method and apparatus are effectively solved.

### BRIEF DESCRIPTION OF THE DRAWINGS

FIG. 1 is a flow diagram of a first embodiment of a binocular image quick processing method of the present invention.

FIG. 2 is a schematic diagram of operation of folding dimensionality reduction of one first-level left eye image into four second-level left eye images.

FIG. 3 is a schematic diagram of operation of tiling dimensionality raising of four third-level left and right eye images into one second-level left and right eye image.

FIG. 4 is a flow diagram of a second embodiment of a binocular image quick processing method of the present invention.

FIG. 5 is a flow diagram of a step S409 of a second embodiment of a binocular image quick processing method of the present invention.

FIG. 6 is a schematic structural diagram of a first embodiment of a binocular image quick processing apparatus of the present invention.

FIG. 7 is a schematic structural diagram of a second embodiment of a binocular image quick processing apparatus of the present invention.

FIG. 8 is an implementation flow diagram of a second embodiment of a binocular image quick processing apparatus of the present invention.

### DETAILED DESCRIPTION

The technical solutions in the embodiments of the present invention will be described below clearly and completely with reference to accompanying drawings in the embodiments of the present invention. Obviously, the described embodiments are only part of the embodiments of the present invention, but not all the embodiments. On the basis of the embodiments in the present invention, all other embodiments obtained by those skilled in the art without inventive efforts fall within the protection scope of the present invention.

The binocular image quick processing method and apparatus of the present invention use an electronic device used for performing quick and accurate phase difference estimation of binocular images. The electronic device includes, but is not limited to a wearable device, a headset device, a medical and health platform, a personal computer, a server computer, a handheld or laptop device, a mobile device (such as a mobile phone, a personal digital assistant (PDA), and a media player), a multiprocessor system, a consumer electronic device, a minicomputer, a mainframe computer, a distributed computing environment including any of the above systems or devices, and so on. The electronic device is preferably an image processing terminal or an image processing server that performs image processing on the binocular images, so as to perform effective image processing by using an acquired binocular visual image phase difference.

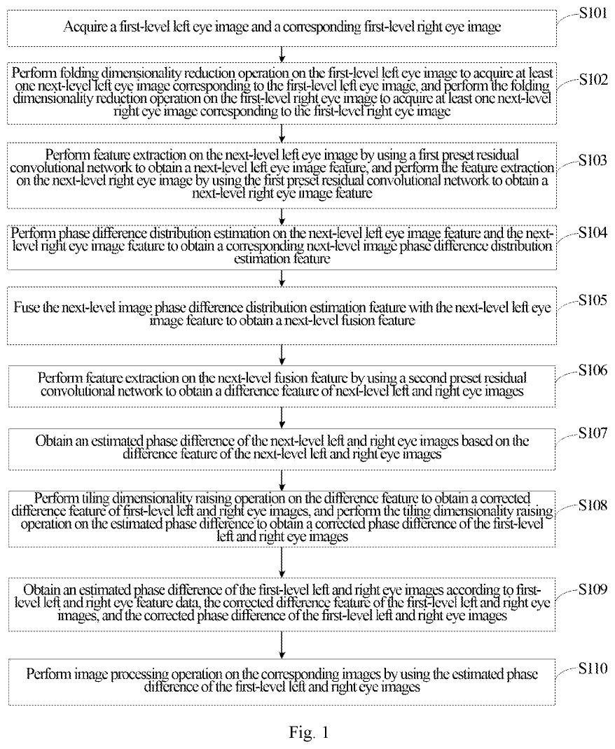

Please refer to FIG. 1, FIG. 1 is a flow diagram of a first embodiment of a binocular image quick processing method of the present invention. The binocular image quick processing method of the present invention may be implemented by using the above electronic device. The binocular image quick processing method of the present invention includes:
S101, a first-level left eye image and a corresponding first-level right eye image are acquired;
S102, folding dimensionality reduction operation is performed on the first-level left eye image to acquire at least one next-level left eye image corresponding to the first-level left eye image, and the folding dimensionality reduction operation is performed on the first-level right eye image to acquire at least one next-level right eye image corresponding to the first-level right eye image;
S103, feature extraction is performed on the next-level left eye image by using a first preset residual convolutional network to obtain a next-level left eye image feature, and the feature extraction is performed on the next-level right eye image by using the first preset residual convolutional network to obtain a next-level right eye image feature;
S104, phase difference distribution estimation is performed on the next-level left eye image feature and the next-level right eye image feature to obtain a corresponding next-level image phase difference distribution estimation feature;
S105, the next-level image phase difference distribution estimation feature is fused with the next-level left eye image feature to obtain a next-level fusion feature;
S106, feature extraction is performed on the next-level fusion feature by using a second preset residual convolutional network to obtain a difference feature of next-level left and right eye images;
S107, an estimated phase difference of the next-level left and right eye images is obtained based on the difference feature of the next-level left and right eye images;
S108, tiling dimensionality raising operation is performed on the difference feature to obtain a corrected difference feature of first-level left and right eye images, and the tiling dimensionality raising operation is performed on the estimated phase difference to obtain a corrected phase difference of the first-level left and right eye images;
S109, an estimated phase difference of the first-level left and right eye images is obtained according to first-level left and right eye feature data, the corrected difference feature of the first-level left and right eye images, and the corrected phase difference of the first-level left and right eye images; and
S110, image processing operation is performed on the corresponding images by using the estimated phase difference of the first-level left and right eye images.

An image processing flow of the binocular image quick processing method of the present embodiment is described in detail below.

In step S101, a binocular image quick processing apparatus (such as an image processing terminal) may acquire the first-level left eye image captured by a binocular camera and the corresponding first-level right eye image. The first-level left eye image and the corresponding first-level right eye image may be combined into a 3d scenario of the corresponding image.

In step S102, because sizes of scenario objects contained in the first-level left eye image and the first-level right eye image are different, in order to better perform feature recognition on the scenario objects with different sizes, the binocular image quick processing apparatus performs the folding dimensionality reduction operation on the first-level left eye image to acquire the plurality of next-level left eye images corresponding to the first-level left eye image, such as four second-level left eye images; and four third-level left eye images may be acquired if the folding dimensionality reduction operation is continued being performed on the second-level left eye image.

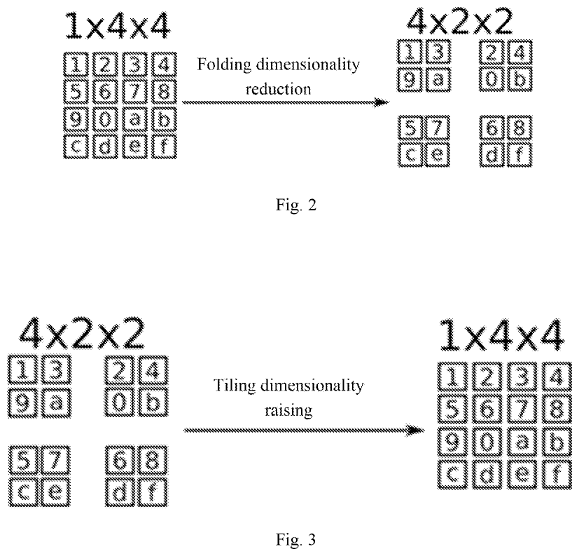

For details, please refer to FIG. 2, FIG. 2 is a schematic diagram of operation of folding dimensionality reduction of one first-level left eye image into the four second-level left eye images. A resolution of the first-level left eye image is 4*4, and a resolution of the second-level left eye image is 2*2.

In a similar way, the binocular image quick processing apparatus may also perform the folding dimensionality reduction operation on the first-level right eye image to acquire the plurality of next-level right eye images corresponding to the first-level right eye image, such as four second-level right eye images; and four third-level right eye images may be acquired if the folding dimensionality reduction operation is continued being performed on the second-level right eye image.

The setting of left and right eye images with different levels or resolutions may better meet needs of object receptive fields in different scenarios.

In step S103, the binocular image quick processing apparatus performs feature extraction on the plurality of next-level left eye images (such as the second-level left eye images and the third-level left eye images) acquired in step S102 by using the first preset residual convolutional network to obtain the plurality of next-level left eye image features at different levels.

Meanwhile, the binocular image quick processing apparatus performs feature extraction on the plurality of next-level right eye images acquired in step S102 by using the first preset residual convolutional network to obtain the plurality of next-level right eye image features at different levels.

In step S104, the binocular image quick processing apparatus performs phase difference distribution estimation on the next-level left eye image feature and the next-level right eye image feature of each level. That is, the possible phase difference on each point in the next-level left eye image feature and the next-level right eye image feature is evaluated to obtain a possibility of a certain phase difference value appearing at this point, namely, feasible distribution of an effective phase difference interval on a certain feature point. Later, the most possible phase difference value of this feature point is obtained through the analysis of this distribution.

When a probability corresponding to the most possible phase difference value of each point in the next-level left eye image feature and the next-level right eye image feature is maximum, an image phase difference distribution estimation feature under this level is obtained.

In step S105, the binocular image quick processing apparatus performs fusion on the next-level image phase difference distribution estimation feature acquired in step S104 and the next-level left eye image feature of the corresponding level acquired in step S103 to obtain the next-level fusion feature. The fusion here may be feature superposition of the next-level image phase difference distribution estimation feature and the next-level left eye image feature of the corresponding level. The fusion operation of the next-level left eye image feature may reduce an impact of an initial difference of the next-level left eye image, improve the accuracy of the subsequent feature extraction operation, and thus improve the accuracy of the subsequent difference feature.

In step S106, the binocular image quick processing apparatus performs feature extraction on the next-level fusion feature acquired in step S105 by using the second preset residual convolutional network to acquire the difference feature of the next-level left and right eye images of the corresponding level.

In step S107, the binocular image quick processing apparatus obtains the estimated phase difference of the next-level left and right eye images based on the acquired difference feature of the next-level left and right eye images. That is, the estimated phase difference of the corresponding next-level left and right eye images is determined based on the preset estimated phase difference corresponding to the difference feature of the next-level left and right eye images. If the preset estimated phase difference corresponding to the difference feature of the next-level left and right eye images is larger, the estimated phase difference of the next-level left and right eye images obtained correspondingly is also larger. If the preset estimated phase difference corresponding to the difference feature of the next-level left and right eye images is smaller, the estimated phase difference of the next-level left and right eye images obtained correspondingly is also smaller. The preset estimated phase difference may be acquired through model training of positive and negative samples.

In step S108, the binocular image quick processing apparatus performs tiling dimensionality raising operation on the difference feature of the next-level left and right eye images acquired in step S106 to obtain the corrected difference feature of the first-level left and right eye images; and the binocular image quick processing apparatus performs the tiling dimensionality raising operation on the estimated phase difference of the next-level left and right eye images acquired in step S107 to obtain the corrected phase difference of the first-level left and right eye images.

For example, the binocular image quick processing apparatus may perform the tiling dimensionality raising operation on a difference feature of third-level left and right eye images to obtain a corrected difference feature of second-level left and right eye images, and the corrected difference feature of the second-level left and right eye images may be used to calculate a difference feature of the second-level left and right eye images; and then the binocular image quick processing apparatus performs the tiling dimensionality raising operation on the difference feature of the second-level left and right eye images to obtain the corrected difference feature of the first-level left and right eye images.

For details, please refer to FIG. 3, and FIG. 3 is a schematic diagram of operation of tiling dimensionality raising of the four third-level left and right eye images into one second-level left and right eye image. A resolution of an image corresponding to the difference feature of the third-level left and right eye images is 2*2, and a resolution of an image corresponding to the second-level left and right eye images is 4*4.

In a similar way, the binocular image quick processing apparatus may perform the tiling dimensionality raising operation on an estimated phase difference of the third-level left and right eye images to obtain a corrected phase difference of the second-level left and right eye images, and the corrected phase difference of the second-level left and right eye images may be used to calculate an estimated phase difference of the second-level left and right eye images; and then the binocular image quick processing apparatus performs the tiling dimensionality raising operation on the estimated phase difference of the second-level left and right eye images to obtain the corrected phase difference of the first-level left and right eye images.

In step S109, the binocular image quick processing apparatus performs feature fusion according to the first-level left and right eye feature data such as the first-level left eye image and the corresponding first-level right eye image acquired in step S101, the corrected difference feature of the first-level left and right eye images acquired in step S108, and the corrected phase difference of the first-level left and right eye images acquired in step S108, and obtains the estimated phase difference of the first-level left and right eye images based on the fusion feature. The corresponding relationship between the fusion feature and the estimated phase difference of the first-level left and right eye images may be acquired through model training of the positive and negative samples.

In step S110, the binocular image quick processing apparatus performs the image processing operation on the corresponding images by using the estimated phase difference of the first left and right eye images acquired in step S109, such as synthesizing the binocular images into a corresponding three-dimensional scenario image, or performing three-dimensional image change operation on a monocular image.

In this way, a binocular image quick processing process of the binocular image quick processing method of the present embodiment is completed.

According to the binocular image quick processing method of the present embodiment, the difference features of the first-level left eye image and the first-level right eye image in different dimensions and the corresponding estimated phase differences can be acquired through the next-level left eye images and next-level right eye images of the plurality of different dimensions, so that the estimated phase difference of the first-level left and right eye images can be quickly and accurately acquired, thereby improving a corresponding image processing efficiency.

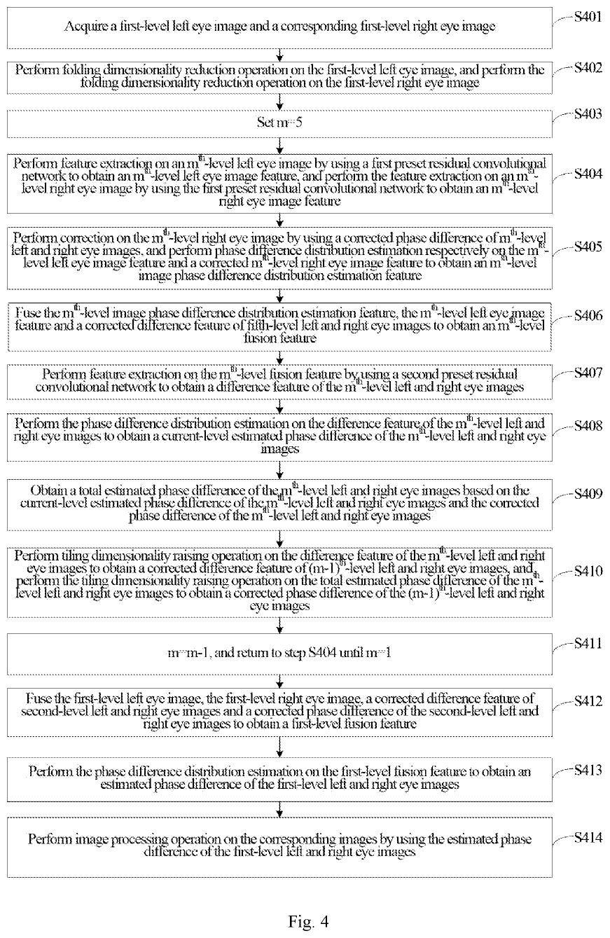

Please refer to FIG. 4, FIG. 4 is a flow diagram of a second embodiment of a binocular image quick processing method of the present invention. The binocular image quick processing method of the present embodiment may be implemented by using the above electronic device. The binocular image quick processing method of the present embodiment includes:
step S401, a first-level left eye image and a corresponding first-level right eye image are acquired;
step S402, folding dimensionality reduction operation is performed on the first-level left eye image to acquire four second-level left eye images; the folding dimensionality reduction operation is performed on the second-level left eye image to acquire four third-level left eye images; and in turn, fourth-level left eye images and fifth-level left eye images are acquired;
the folding dimensionality reduction operation is performed on the first-level right eye image to acquire four second-level right eye images; the folding dimensionality reduction operation is performed on the second-level right eye image to acquire four third-level right eye images; and in turn, fourth-level right eye images and fifth-level right eye images are acquired;
step S403, m=5 is set;
step S404, feature extraction is performed on an m^{th}-level left eye image by using a first preset residual convolutional network to obtain an m^{th}-level left eye image feature, and the feature extraction is performed on an m^{th}-level right eye image by using the first preset residual convolutional network to obtain an m^{th}-level right eye image feature;
step S405, correction is performed on the m^{th}-level right eye image by using a corrected phase difference of m^{th}-level left and right eye images, and phase difference distribution estimation is performed respectively on the m^{th}-level left eye image feature and a corrected m^{th}-level right eye image feature to obtain an m^{th}-level image phase difference distribution estimation feature;
step S406, the m^{th}-level image phase difference distribution estimation feature, the m^{th}-level left eye image feature and a corrected difference feature of fifth-level left and right eye images are fused to obtain an m^{th}-level fusion feature
step S407, feature extraction is performed on the m^{th}-level fusion feature by using a second preset residual convolutional network to obtain a difference feature of the m^{th}-level left and right eye images;
step S408, the phase difference distribution estimation is performed on the difference feature of the m^{th}-level left and right eye images to obtain a current-level estimated phase difference of the m^{th}-level left and right eye images;
step S409, a total estimated phase difference of the m^{th}-level left and right eye images is obtained based on the current-level estimated phase difference of the m^{th}-level left and right eye images and the corrected phase difference of the m^{th}-level left and right eye images;
step S410, tiling dimensionality raising operation is performed on the difference feature of the m^{th}-level left and right eye images to obtain a corrected difference feature of (m−1)^{th}-level left and right eye images, and the tiling dimensionality raising operation is performed on the total estimated phase difference of the m^{th}-level left and right eye images to obtain a corrected phase difference of the (m−1)^{th}-level left and right eye images;
step S411, m=m−1, and step S404 is returned until m=1;
step S412, the first-level left eye image, the first-level right eye image, a corrected difference feature of second-level left and right eye images and a corrected phase difference of the second-level left and right eye images are fused to obtain a first-level fusion feature;
step S413, the phase difference distribution estimation is performed on the first-level fusion feature to obtain an estimated phase difference of the first-level left and right eye images; and
step S414, image processing operation is performed on the corresponding images by using the estimated phase difference of the first-level left and right eye images.

An image processing flow of the binocular image quick processing method of the present embodiment is described in detail below.

In step S401, a binocular image quick processing apparatus may acquire the first-level left eye image captured by a binocular camera and the corresponding first-level right eye image. The first-level left eye image and the corresponding first-level right eye image may be combined into a 3d scenario of the corresponding image.

In step S402, the binocular image quick processing apparatus performs the folding dimensionality reduction operation on the first-level left eye image to acquire the plurality of next-level left eye images corresponding to the first-level left eye image, such as four second-level left eye images; four third-level left eye images may be acquired if the folding dimensionality reduction operation is continued being performed on the second-level left eye image; and in turn, the fourth-level left eye images and the fifth-level left eye images are acquired.

In a similar way, the binocular image quick processing apparatus may also perform the folding dimensionality reduction operation on the first-level right eye image to acquire the plurality of next-level right eye images corresponding to the first-level right eye image, such as four second-level right eye images; four third-level right eye images may be acquired if the folding dimensionality reduction operation is continued being performed on the second-level right eye image; and in turn, the fourth-level right eye images and the fifth-level right eye images are acquired.

In step S403, the binocular image quick processing apparatus sets a count value m, and the current count value m is the level number of the next-level image with the lowest resolution, that is, m=5.

In step S404, the binocular image quick processing apparatus performs the feature extraction on the fifth-level left eye images by using the first preset residual convolutional network to obtain a fifth-level left eye image feature. Meanwhile, the binocular image quick processing apparatus performs the feature extraction on the fifth-level right eye images by using the first preset residual convolutional network to obtain a fifth-level right eye image feature.

In step S405, since there is no corrected phase difference of fifth-level left and right eye images, the binocular image quick processing apparatus performs phase difference distribution estimation on the fifth-level left eye image feature and the fifth-level right eye image feature respectively. That is, the possible phase difference on each point in the fifth-level left eye image feature and the fifth-level right eye image feature is evaluated to obtain the possibility of a certain phase difference value appearing at this point, namely, feasible distribution of an effective phase difference interval on a certain feature point. Later, the most possible phase difference value of this feature point is obtained through the analysis of this distribution.

When a probability corresponding to the most possible phase difference value of each point in the fifth-level left eye image feature and the fifth-level right eye image feature is maximum, the fifth-level image phase difference distribution estimation feature is obtained.

In step S406, since there is no corrected difference feature of the fifth-level left and right eye images, the binocular image quick processing apparatus fuses the fifth-level image phase difference distribution estimation feature with the fifth-level left eye image feature to obtain a fifth-level fusion feature. The fusion here may be feature superposition of the fifth-level image phase difference distribution estimation feature and the fifth-level left eye image feature. The fusion operation of the fifth-level left eye image feature may reduce an impact of an initial difference of the fifth-level left eye image, improve the accuracy of the subsequent feature extraction operation, and thus improve the accuracy of the subsequent difference feature.

In step S407, the binocular image quick processing apparatus performs the feature extraction on the fifth-level fusion feature by using the second preset residual convolutional network to acquire the difference feature of the fifth-level left and right eye images.

In step S408, the binocular image quick processing apparatus obtains the estimated phase difference of the fifth-level left and right eye images based on the difference feature of the fifth-level left and right eye images. That is, the estimated phase difference of the corresponding fifth-level left and right eye images is determined based on the preset estimated phase difference corresponding to the difference feature of the fifth-level left and right eye images. If the preset estimated phase difference corresponding to the difference feature of the fifth-level left and right eye images is larger, the estimated phase difference of the fifth-level left and right eye images obtained correspondingly is also larger. If the preset estimated phase difference corresponding to the difference feature of the fifth-level left and right eye images is smaller, the estimated phase difference of the fifth-level left and right eye images obtained correspondingly is also smaller. The preset estimated phase difference may be acquired through model training of positive and negative samples.

In step S409, since there is no corrected phase difference of the fifth-level left and right eye images, the binocular image quick processing apparatus directly takes the estimated phase difference of the fifth-level left and right eye images as a total estimated phase difference of the fifth-level left and right eye images.

In step S410, the binocular image quick processing apparatus performs tiling dimensionality raising operation on the difference feature of the fifth-level left and right eye images acquired in step S407 to obtain the corrected difference feature of the fourth-level left and right eye images; and the binocular image quick processing apparatus performs the tiling dimensionality raising operation on the total estimated phase difference of the fifth-level left and right eye images acquired in step S409 to obtain the corrected phase difference of the fourth-level left and right eye images.

In step S411, the binocular image quick processing apparatus sets the count value m minus one, that is, executes m=m−1, and then returns to step S404.

Specifically, in step S404, the binocular image quick processing apparatus acquires a fourth-level left eye image feature and a fourth-level right eye image feature. In step S405, the binocular image quick processing apparatus performs correction on a fourth-level right eye image by using a corrected phase difference of fourth-level left and right eye images, and performs phase difference distribution estimation respectively on the fourth-level left eye image feature and a corrected fourth-level right eye image feature to obtain a fourth-level image phase difference distribution estimation feature. In step S406, the binocular image quick processing apparatus fuses the fourth-level image phase difference distribution estimation feature, the fourth-level left eye image feature and a corrected difference feature of the fourth-level left and right eye images to obtain a fourth-level fusion feature. In step S407, the binocular image quick processing apparatus obtains a difference feature of the fourth-level left and right eye images. In step S408, the binocular image quick processing apparatus obtains a current-level estimated phase difference of the fourth-level left and right eye images. In step S409, the binocular image quick processing apparatus obtains a total estimated phase difference of the fourth-level left and right eye images based on the current-level estimated phase difference of the fourth-level left and right eye images and the corrected phase difference of the fourth-level left and right eye images. In step S410, the binocular image quick processing apparatus performs tiling dimensionality raising operation on the difference feature of the fourth-level left and right eye images to obtain a corrected difference feature of third-level left and right eye images; and the binocular image quick processing apparatus performs the tiling dimensionality raising operation on the total estimated phase difference of the fourth-level left and right eye images to obtain a corrected phase difference of the third-level left and right eye images.

The binocular image quick processing apparatus sets the count value m minus one again, returns to step S404, and repeats until m=1. At this time, the binocular image quick processing apparatus acquires a corrected difference feature of second-level left and right eye images and a corrected phase difference of the second-level left and right eye images.

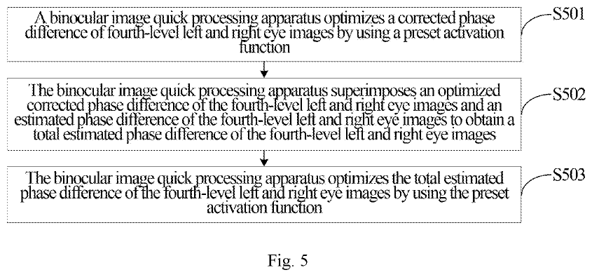

Specifically, the specific step that the binocular image quick processing apparatus obtains the total estimated phase difference of the fourth-level left and right eye images based on the current-level estimated phase difference of the fourth-level left and right eye images and the corrected phase difference of the fourth-level left and right eye images please refer to FIG. 5. FIG. 5 is a flow diagram of step S409 of the second embodiment of the binocular image quick processing method of the present invention. The step S409 includes:
step S501, the binocular image quick processing apparatus optimizes the corrected phase difference of the fourth-level left and right eye images by using a preset activation function.
Step S502, the binocular image quick processing apparatus superimposes an optimized corrected phase difference of the fourth-level left and right eye images and the estimated phase difference of the fourth-level left and right eye images to obtain the total estimated phase difference of the fourth-level left and right eye images.
Step S503, the binocular image quick processing apparatus optimizes the total estimated phase difference of the fourth-level left and right eye images by using the preset activation function.

The preset activation function here can be a segmented reversible TrLU type activation function, that is:

$$f ( x ) = \{ \begin{matrix}x , & x \geq 0 \\ γ x , & x <= 0\end{matrix} ,$$

$$γ \geq 0 ,$$

When γ=0, the function is a standard ReLU function, and when γ>0, the function is a LeakyReLU function. The preset activation function can effectively improve significant precision, reduce the model lift and shorten running time in a model training stage and a model deployment stage.

Further, the preset activation function here may further be a convolved TrLU type activation function for phase difference prediction, that is:

$$g ( x ) = \{ \begin{matrix}γ ( x - α ) + α , & x < α \\ r ( x - β ) + β , & x > β \\ x , & α \leq x \leq β\end{matrix} ,$$

Where α and β are an upper boundary and lower boundary of the difference effective interval respectively. The preset activation function is applied to the convolution of a predicted phase difference to be able to improve the precision of an output result.

In step S412, the binocular image quick processing apparatus fuses the first-level left eye image, the first-level right eye image, the corrected difference feature of the second-level left and right eye images and the corrected phase difference of the second-level left and right eye images are fused to obtain a first-level fusion feature. The fusion operation here may be feature superposition of above image features, the corrected difference feature and a corrected difference feature.

In step S413, the binocular image quick processing apparatus performs the phase difference distribution estimation on the first-level fusion feature obtained in step S412 to obtain the estimated phase difference of the first-level left and right eye images. The corresponding relationship between the first-level fusion feature and the estimated phase difference of the first-level left and right eye images may be acquired through model training of positive and negative samples.

In step s414, the binocular image quick processing apparatus performs the image processing operation on the corresponding images by using the estimated phase difference of the first left and right eye images acquired in step s413, such as synthesizing binocular images into a corresponding three-dimensional scenario image, or performing three-dimensional image change operation on a monocular image.

In this way, a binocular image quick processing process of the binocular image quick processing method of the present embodiment is completed.

On the basis of the first embodiment, the binocular image quick processing method of the present embodiment uses the next-level left and right eye images to correct the estimated phase difference of the previous-level left and right eye images of adjacent levels, so that the difference feature of each level and the corresponding estimated phase difference can be accurately fused into the difference feature and estimated phase difference of the previous level, and then finally fused into the first-level left eye image and the first-level right eye image, and thus the estimated phase difference of the first-level left and right eye images can be accurately obtained, which further improves the corresponding image processing efficiency.

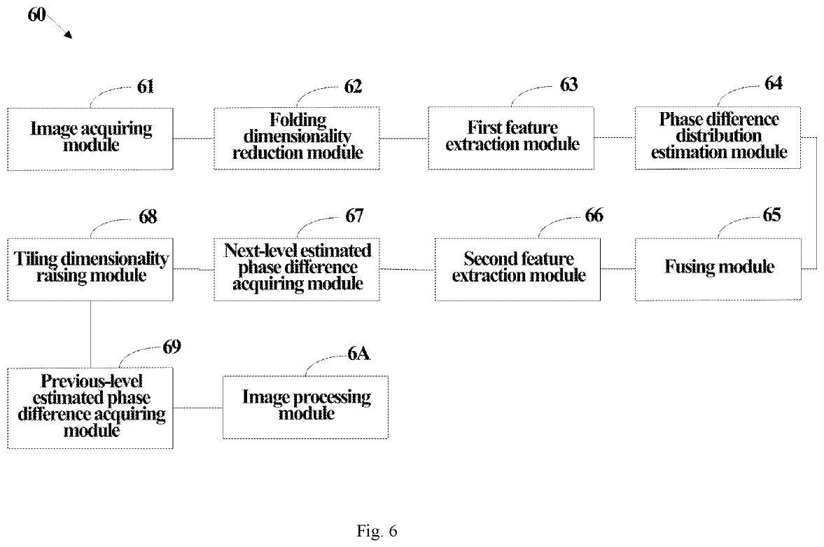

The present invention further provides a binocular image quick processing apparatus. Please refer to FIG. 6, FIG. 6 is a schematic structural diagram of a first embodiment of a binocular image quick processing apparatus of the present invention. The binocular image quick processing apparatus of the present embodiment may be implemented by using the first embodiment of the above binocular image quick processing method. The binocular image quick processing apparatus 60 of the present embodiment includes an image acquiring module 61, a folding dimensionality reduction module 62, a first feature extraction module 63, a phase difference distribution estimation module 64, a fusion module 65, a second feature extraction module 66, a next-level estimated phase difference acquiring module 67, a tiling dimensionality raising module 68, a previous-level estimated phase difference acquiring module 69, and an image processing module 6A.

The image acquiring module 61 is configured to acquire a first-level left eye image and a corresponding first-level right eye image; the folding dimensionality reduction module 62 is configured to perform folding dimensionality reduction operation on the first-level left eye image to acquire at least one next-level left eye image corresponding to the first-level left eye image, and perform the folding dimensionality reduction operation on the first-level right eye image to acquire at least one next-level right eye image corresponding to the first-level right eye image; the first feature extraction module 63 is configured to perform feature extraction on the next-level left eye image by using a first preset residual convolutional network to obtain a next-level left eye image feature, and perform feature extraction on the next-level right eye image by using the first preset residual convolutional network to obtain a next-level right eye image feature; the phase difference distribution estimation module 64 is configured to perform phase difference distribution estimation on the next-level left eye image feature and the next-level right eye image feature to obtain a corresponding next-level image phase difference distribution estimation feature; the fusing module 65 is configured to fuse the next-level image phase difference distribution estimation feature with the next-level left eye image feature to obtain a next-level fusion feature; the second feature extraction module 66 is configured to perform feature extraction on the next-level fusion feature by using a second preset residual convolutional network to obtain a difference feature of next-level left and right eye images; the next-level estimated phase difference acquiring module 67 is configured to obtain an estimated phase difference of the next-level left and right eye images based on the difference feature of the next-level left and right eye images; the tiling dimensionality raising module 68 is configured to perform tiling dimensionality raising operation on the difference feature to obtain a corrected difference feature of first-level left and right eye images, and perform the tiling dimensionality raising operation on the estimated phase difference to obtain a corrected phase difference of the first-level left and right eye images; the previous-level estimated phase difference acquiring module 69 is configured to obtain an estimated phase difference of the first-level left and right eye images according to first-level left and right eye feature data, the corrected difference feature of the first-level left and right eye images, and the corrected phase difference of the first-level left and right eye images; and the image processing module 6A is configured to perform image processing operation on the corresponding images by using the estimated phase difference of the first-level left and right eye images.

When the binocular image quick processing apparatus 60 of the present embodiment is used, first the image acquiring module 61 may acquire the first-level left eye image captured by a binocular camera and the corresponding first-level right eye image. The first-level left eye image and the corresponding first-level right eye image may be combined into a 3d scenario of the corresponding image.

Since sizes of scenario objects contained in the first-level left eye image and the first-level right eye image are different, in order to better perform feature recognition on the scenario objects with the different sizes, a left-eye image folding dimensionality reduction unit of the folding dimensionality reduction module 62 performs the folding dimensionality reduction operation on the first-level left eye image to acquire the plurality of next-level left eye images corresponding to the first-level left eye image, such as four second-level left eye images; and four third-level left eye images may be acquired if the folding dimensionality reduction operation is continued being performed on the second-level left eye image. An image resolution of the second-level left eye image is 1/4 of an image resolution of the first-level left eye image, and an image resolution of the third-level left eye image is 1/4 of an image resolution of the second-level left eye image.

In a similar way, a right-eye image folding dimensionality reduction unit of the folding dimensionality reduction module 62 performs the folding dimensionality reduction operation on the first-level right eye image to acquire the plurality of next-level right eye images corresponding to the first-level right eye image, such as four second-level right eye images; and four third-level right eye images may be acquired if the folding dimensionality reduction operation is continued being performed on the second-level right eye image. An image resolution of the second-level right eye image is 1/4 of an image resolution of the first-level right eye image, and an image resolution of the third-level right eye image is 1/4 of an image resolution of the second-level right eye image.

The setting of left and right eye images with different levels or resolutions may better meet needs of object receptive fields in different scenarios.

Then the first feature extraction module 63 performs feature extraction on the plurality of acquired next-level left eye images (such as the second-level left eye images and the third-level left eye images) by using the first preset residual convolutional network to obtain the plurality of next-level left eye image features at different levels.

Meanwhile, the first feature extraction module 63 performs feature extraction on the plurality of acquired next-level right eye images by using the first preset residual convolutional network to obtain the plurality of next-level right eye image features at different levels.

Then the phase difference distribution estimation module 64 performs phase difference analysis estimation on the next-level left eye image feature and the next-level right eye image feature of each level. That is, the possible phase difference on each point in the next-level left eye image feature and the next-level right eye image feature is evaluated to obtain the possibility of a certain phase difference value appearing at this point, namely, feasible distribution of an effective phase difference interval on a certain feature point. Later, the most possible phase difference value of this feature point is obtained through the analysis of this distribution.

When a probability corresponding to the most possible phase difference value of each point in the next-level left eye image feature and the next-level right eye image feature is maximum, the image phase difference distribution estimation feature under this level is obtained.

Subsequently the fusing module 65 fuses the acquired next-level image phase difference distribution estimation feature with the acquired next-level left eye image feature of the corresponding level to obtain a next-level fusion feature. The fusion here may be feature superposition of the next-level image phase difference distribution estimation feature and the next-level left eye image feature of the corresponding level. The fusion operation of the next-level left eye image feature may reduce an impact of an initial difference of the next-level left eye image, improve the accuracy of the subsequent feature extraction operation, and thus improve the accuracy of the subsequent difference feature.

Then, the second feature extraction module 66 performs the feature extraction on the acquired next-level fusion feature by using a second preset residual convolutional network to acquire the difference feature of next-level left and right eye images of the corresponding level.

Subsequently, the next-level estimated phase difference acquiring module 67 obtains the estimated phase difference of the next-level left and right eye images based on the acquired difference feature of the next-level left and right eye images.

That is, the estimated phase difference of the corresponding next-level left and right eye images is determined based on the preset estimated phase difference corresponding to the difference feature of the next-level left and right eye images. If the preset estimated phase difference corresponding to the difference feature of the next-level left and right eye images is larger, the estimated phase difference of the next-level left and right eye images obtained correspondingly is also larger. If the preset estimated phase difference corresponding to the difference feature of the next-level left and right eye images is smaller, the estimated phase difference of the next-level left and right eye images obtained correspondingly is also smaller. The preset estimated phase difference may be acquired through model training of positive and negative samples.

Then tiling dimensionality raising module 68 performs the tiling dimensionality raising operation on the acquired difference feature of the next-level left and right eye images to obtain the corrected difference feature of the first-level left and right eye images. The tiling dimensionality raising module 68 performs the tiling dimensionality raising operation on the acquired estimated phase difference of the next-level left and right eye images to obtain the corrected phase difference of the first-level left and right eye images.

For example, the tiling dimensionality raising module 68 may perform the tiling dimensionality raising operation on a difference feature of third-level left and right eye images to obtain a corrected difference feature of second-level left and right eye images, and the corrected difference feature of the second-level left and right eye images may be used to calculate a difference feature of the second-level left and right eye images; and then the tiling dimensionality raising module 68 performs the tiling dimensionality raising operation on the difference feature of the second-level left and right eye images to obtain the corrected difference feature of the first-level left and right eye images.

In a similar way, the tiling dimensionality raising module 68 may perform the tiling dimensionality raising operation on an estimated phase difference of the third-level left and right eye images to obtain a corrected phase difference of the second-level left and right eye images, and the corrected phase difference of the second-level left and right eye images may be used to calculate an estimated phase difference of the second-level left and right eye images; and then the tiling dimensionality raising module 68 performs the tiling dimensionality raising operation on the estimated phase difference of the second-level left and right eye images to obtain the corrected phase difference of the first-level left and right eye images.

Subsequently, the previous-level estimated phase difference acquiring module 69 performs feature fusion according to the acquired first-level left and right eye feature data such as the first-level left eye image and the corresponding first-level right eye image, the corrected difference feature of the first-level left and right eye images, and the corrected phase difference of the first-level left and right eye images, and obtains the estimated phase difference of the first-level left and right eye images based on the fusion feature. The corresponding relationship between the fusion feature and the estimated phase difference of the first-level left and right eye images may be acquired through model training of the positive and negative samples.

Finally, the image processing module 6A performs the image processing operation on the corresponding images by using the estimated phase difference of the first left and right eye images, such as synthesizing the binocular images into a corresponding three-dimensional scenario image, or performing three-dimensional image change operation on a monocular image.

In this way, a binocular image quick processing process of the binocular image quick processing apparatus 60 of the present embodiment is completed.

According to the binocular image quick processing apparatus of the present embodiment, the difference features of the first-level left eye image and the first-level right eye image in different dimensions and the corresponding estimated phase differences can be acquired through the next-level left eye images and next-level right eye images of the plurality of different dimensions, so that the estimated phase difference of the first-level left and right eye images can be quickly and accurately acquired, thereby improving a corresponding image processing efficiency.

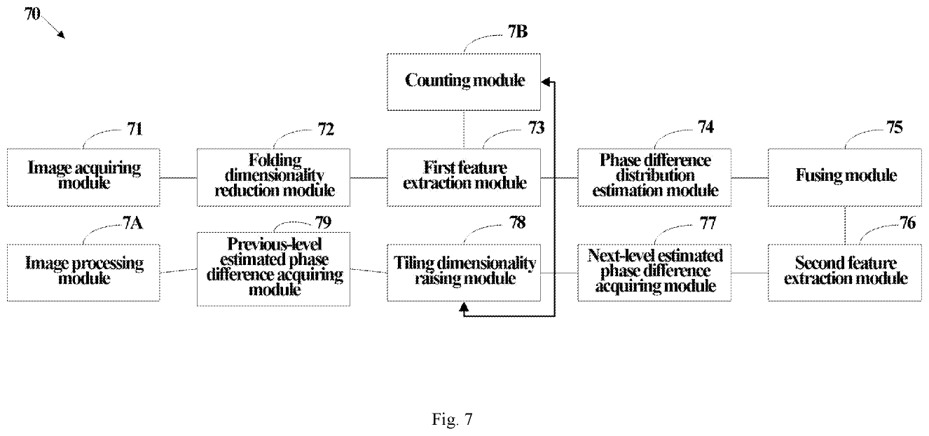

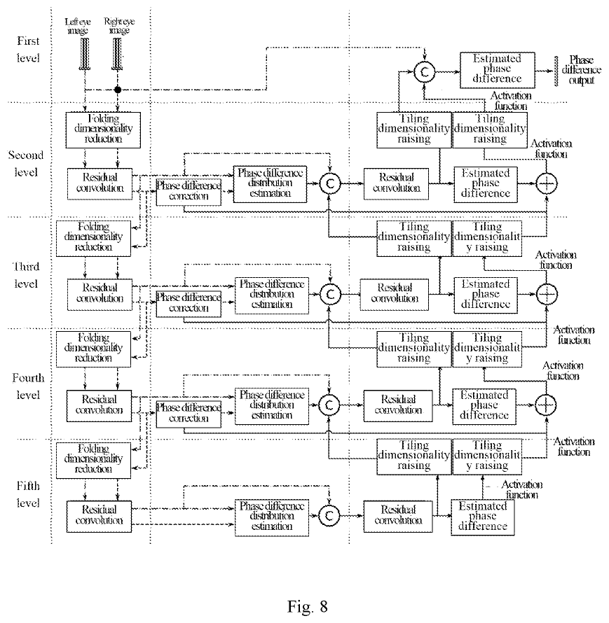

Please refer to FIG. 7 and FIG. 8, FIG. 7 is a schematic structural diagram of a second embodiment of a binocular image quick processing apparatus of the present invention. FIG. 8 is an implementation flow diagram of the second embodiment of the binocular image quick processing apparatus of the present invention. The binocular image quick processing apparatus of the present embodiment may be implemented by using the second embodiment of the above binocular image quick processing method. On the basis of the first embodiment, the binocular image quick processing apparatus 70 of the present embodiment further includes a counting module 7B for performing counting operation on the count value m.

When the binocular image quick processing apparatus of the present embodiment is used, first an image acquiring module 71 may acquire a first-level left eye image captured by a binocular camera and a corresponding first-level right eye image. The first-level left eye image and the corresponding first-level right eye image may be combined into a 3d scenario of the corresponding image.

Subsequently, a folding dimensionality reduction module 72 performs folding dimensionality reduction operation on the first-level left eye image to acquire a plurality of next-level left eye images corresponding to the first-level left eye image, such as four second-level left eye images; four third-level left eye images may be acquired if the folding dimensionality reduction operation is continued being performed on the second-level left eye image; and in turn, fourth-level left eye images and fifth-level left eye images are acquired.

In a similar way, the folding dimensionality reduction module 72 may also perform the folding dimensionality reduction operation on the first-level right eye image to acquire a plurality of next-level right eye images corresponding to the first-level right eye image, such as four second-level right eye images; four third-level right eye images may be acquired if the folding dimensionality reduction operation is continued being performed on the second-level right eye image; and in turn, fourth-level right eye images and fifth-level right eye images are acquired.

Then, the counting module 7B sets a count value m, and the current count value m is the level number of the next-level image with a lowest resolution, that is, m=5.

Subsequently, a first feature extraction module 73 performs feature extraction on the fifth-level left eye image by using a first preset residual convolutional network to obtain a fifth-level left eye image feature. Meanwhile, the first feature extraction module 73 performs the feature extraction on the fifth-level right eye image by using the first preset residual convolutional network to obtain a fifth-level right eye image feature.

Since there is no corrected phase difference of fifth-level left and right eye images, a phase difference distribution estimation module 74 performs phase difference distribution estimation on the fifth-level left eye image feature and the fifth-level right eye image feature respectively. That is, a possible phase difference on each point in the fifth-level left eye image feature and the fifth-level right eye image feature is evaluated to obtain a possibility of a certain phase difference value appearing at this point, namely, feasible distribution of an effective phase difference interval on a certain feature point. Later, a most possible phase difference value of this feature point is obtained through the analysis of this distribution.

When a probability corresponding to the most possible phase difference value of each point in the fifth-level left eye image feature and the fifth-level right eye image feature is maximum, a fifth-level image phase difference distribution estimation feature is obtained.

Since there is no corrected difference feature of the fifth-level left and right eye images, a fusing module 75 fuses the fifth-level image phase difference distribution estimation feature with the fifth-level left eye image feature to obtain a fifth-level fusion feature. The fusion here may be feature superposition of the fifth-level image phase difference distribution estimation feature and the fifth-level left eye image feature. The fusion operation of the fifth-level left eye image feature may reduce an impact of an initial difference of the fifth-level left eye image, improve the accuracy of the subsequent feature extraction operation, and thus improve the accuracy of the subsequent difference feature.

Then, a second feature extraction module 76 performs the feature extraction on the fifth-level fusion feature by using a second preset residual convolutional network to acquire a difference feature of the fifth-level left and right eye images.

Subsequently, a next-level estimated phase difference acquiring module 77 obtains an estimated phase difference of the fifth-level left and right eye images based on the difference feature of the fifth-level left and right eye images. That is, the estimated phase difference of the corresponding fifth-level left and right eye images is determined based on a preset estimated phase difference corresponding to the difference feature of the fifth-level left and right eye images. If the preset estimated phase difference corresponding to the difference feature of the fifth-level left and right eye images is larger, the estimated phase difference of the fifth-level left and right eye images obtained correspondingly is also larger. If the preset estimated phase difference corresponding to the difference feature of the fifth-level left and right eye images is small, the estimated phase difference of the fifth-level left and right eye images obtained correspondingly is also small. The preset estimated phase difference may be acquired through model training of positive and negative samples.

Since there is no corrected phase difference of the fifth-level left and right eye images, the next-level estimated phase difference acquiring module 77 directly takes the estimated phase difference of the fifth-level left and right eye images as a total estimated phase difference of the fifth-level left and right eye images.

Then, a tiling dimensionality raising module 78 performs tiling dimensionality raising operation on the difference feature of the fifth-level left and right eye images to obtain a corrected difference feature of fourth-level left and right eye images. The tiling dimensionality raising module 78 performs the tiling dimensionality raising operation on the total estimated phase difference of the fifth-level left and right eye images to obtain a corrected phase difference of the fourth-level left and right eye images.

Subsequently, the counting module 7B sets the count value m minus one, that is, executes m=m−1, and then returns to the first feature extraction module 73 to perform feature extraction on a fourth-level left eye image feature and a fourth-level right eye image feature.

Specifically, please refer to the relevant description in the second embodiment of the above binocular image quick processing method and the subsequent implementation flow in FIG. 8.

Repetition is made until m=1. At this time, the binocular image quick processing apparatus 70 acquires a corrected difference feature of second-level left and right eye images and a corrected phase difference of the second-level left and right eye images.

A previous-level estimated phase difference acquiring module 79 fuses the first-level left eye image, the first-level right eye image, the corrected difference feature of the second-level left and right eye images and the corrected phase difference of the second-level left and right eye images to obtain a first-level fusion feature. The fusion operation here may be feature superposition of the above image features, corrected difference features and corrected difference features.

Subsequently, the previous-level estimated phase difference acquiring module 79 performs the phase difference distribution estimation on the first-level fusion feature to obtain an estimated phase difference of the first-level left and right eye images. The corresponding relationship between the first-level fusion feature and the estimated phase difference of the first-level left and right eye images may be acquired through model training of the positive and negative samples.

Finally, an image processing module 7A performs the image processing operation on the corresponding images by using the estimated phase difference of the first left and right eye images, such as synthesizing binocular images into a corresponding three-dimensional scenario image, or performing three-dimensional image change operation on a monocular image.

In this way, a binocular image quick processing process of the binocular image quick processing apparatus 70 of the present embodiment is completed.

On the basis of the first embodiment, the binocular image quick processing apparatus of the present embodiment uses the next-level left and right eye images to correct the estimated phase difference of the previous-level left and right eye images of adjacent levels, so that the difference feature of each level and the corresponding estimated phase difference may be accurately fused into the difference feature and estimated phase difference of the previous level, and then finally fused into the first-level left eye image and the first-level right eye image, and thus the estimated phase difference of the first-level left and right eye images may be accurately acquired, which further improves the corresponding image processing efficiency.

Please refer to FIG. 8, the binocular image quick processing method and apparatus of the present invention generate a feature map at multiple resolutions by performing a plurality of folding dimensionality reduction on the first-level left eye image and the corresponding first-level right eye image. A resolution level may be adjusted according to an actual processing image to ensure that minimum resolution phase difference evaluation may include the maximum phase difference in the binocular images. At each resolution, a phase difference actual value is predicted according to the phase difference distribution generated by left and right eye image feature maps and feature maps of the images at this resolution. The phase difference obtained from the prediction and the feature maps used to generate the prediction will be transferred to the previous-level left and right eye images through the tiling dimensionality raising operation for fusion processing, and a dense phase difference map of an original resolution is generated through a plurality of tiling dimensionality raising operation, so that the image processing operation can be performed on the corresponding binocular images and monocular images.

The binocular image quick processing method and apparatus of the present invention may acquire the difference features of the first-level left eye image and the first-level right eye image in different dimensions and the corresponding estimated phase differences through the next-level left eye images and next-level right eye images of the plurality of different dimensions, so that the estimated phase difference of the first-level left and right eye images may be quickly and accurately acquired, thereby improving a corresponding image processing efficiency; and the technical problems of a larger difference and lower accuracy of a binocular visual image phase difference acquired by an existing binocular image quick processing method and apparatus are effectively solved.

To sum up, although the present invention has been disclosed as above based on the embodiments, sequence numbers before the embodiments are used only for the convenience of description, and do not limit the order of the embodiments of the present invention. Moreover, the above embodiments are not intended to limit the present invention. Those ordinarily skilled in the art can make various changes and refinements without departing from the spirit and scope of the present invention. Therefore, the scope of protection of the present invention is subject to the scope defined in the claims.

What is claimed is:

1. A binocular image quick processing method, comprising:
acquiring a first-level left eye image and a corresponding first-level right eye image;
performing folding dimensionality reduction operation on the first-level left eye image to acquire at least one next-level left eye image corresponding to the first-level left eye image, and performing the folding dimensionality reduction operation on the first-level right eye image to acquire at least one next-level right eye image corresponding to the first-level right eye image;
performing feature extraction on the next-level left eye image by using a first preset residual convolutional network to obtain a next-level left eye image feature, and performing the feature extraction on the next-level right eye image by using the first preset residual convolutional network to obtain a next-level right eye image feature;
performing phase difference distribution estimation on the next-level left eye image feature and the next-level right eye image feature to obtain a corresponding next-level image phase difference distribution estimation feature;
fusing the next-level image phase difference distribution estimation feature with the next-level left eye image feature to obtain a next-level fusion feature;
performing feature extraction on the next-level fusion feature by using a second preset residual convolutional network to obtain a difference feature of next-level left and right eye images;
obtaining an estimated phase difference of the next-level left and right eye images based on the difference feature of the next-level left and right eye images;
performing tiling dimensionality raising operation on the difference feature to obtain a corrected difference feature of first-level left and right eye images, and performing the tiling dimensionality raising operation on the estimated phase difference to obtain a corrected phase difference of the first-level left and right eye images;
obtaining an estimated phase difference of the first-level left and right eye images according to first-level left and right eye feature data, the corrected difference feature of the first-level left and right eye images, and the corrected phase difference of the first-level left and right eye images; and
performing image processing operation on the corresponding images by using the estimated phase difference of the first-level left and right eye images.

2. The binocular image quick processing method according to claim 1, wherein the next-level left eye image comprises an n^{th}-level left eye image, and the next-level right eye image comprises an n^{th}-level right eye image, wherein n is a positive integer greater than or equal to 1; and
the step of performing the folding dimensionality reduction operation on the first-level left eye image to acquire the at least one next-level left eye image corresponding to the first-level left eye image, and performing the folding dimensionality reduction operation on the first-level right eye image to acquire the at least one next-level right eye image corresponding to the first-level right eye image comprises:
performing the folding dimensionality reduction operation on the first-level left eye image to acquire the n^{th}-level left eye image corresponding to the first-level left eye image, wherein an image resolution of the n^{th}-level left eye image is 1/[4\hat{ }(n−1)] of an image resolution of the first-level left eye image; and
performing the folding dimensionality reduction operation on the first-level right eye image to acquire the n^{th}-level right eye image corresponding to the first-level right eye image, wherein an image resolution of the n^{th}-level right eye image is 1/[4\hat{ }(n−1)] of an image resolution of the first-level right eye image.

3. The binocular image quick processing method according to claim 1, further comprising:
setting m=i, wherein i is a positive integer greater than or equal to 3;
performing feature extraction on an m^{th}-level left eye image by using the first preset residual convolutional network to obtain an m^{th}-level left eye image feature, and performing the feature extraction on an m^{th}-level right eye image by using the first preset residual convolutional network to obtain an m^{th}-level right eye image feature;
performing correction on the m^{th}-level right eye image by using a corrected phase difference of m^{th}-level left and right eye images, and performing the phase difference distribution estimation respectively on the m^{th}-level left eye image feature and a corrected m^{th}-level right eye image feature to obtain an m^{th}-level image phase difference distribution estimation feature;
fusing the m^{th}-level image phase difference distribution estimation feature, the m^{th}-level left eye image feature and a corrected difference feature of the m^{th}-level left and right eye images to obtain an m^{th}-level fusion feature;
performing feature extraction on the m^{th}-level fusion feature by using the second preset residual convolutional network to obtain a difference feature of the m^{th}-level left and right eye images;
performing the phase difference distribution estimation on the difference feature of the m^{th}-level left and right eye images to obtain a current-level estimated phase difference of the m^{th}-level left and right eye images;
obtaining a total estimated phase difference of the m^{th}-level left and right eye images based on the current-level estimated phase difference of the m^{th}-level left and right eye images and the corrected phase difference of the m^{th}-level left and right eye images;
performing the tiling dimensionality raising operation on the difference feature of the m^{th}-level left and right eye images to obtain a corrected difference feature of (m−1)^{th}-level left and right eye images, and performing the tiling dimensionality raising operation on the total estimated phase difference of the m^{th}-level left and right eye images to obtain a corrected phase difference of the (m−1)^{th}-level left and right eye images; and
m=m−1, and returning to the step of the operation of performing the feature extraction by using the first preset residual convolutional network until m=1.

4. The binocular image quick processing method according to claim 3, further comprising:
fusing, when m=1, the first-level left eye image, the first-level right eye image, a corrected difference feature of second-level left and right eye images and a corrected phase difference of the second-level left and right eye images to obtain a first-level fusion feature; and
performing the phase difference distribution estimation on the first-level fusion feature to obtain the estimated phase difference of the first-level left and right eye images.

5. The binocular image quick processing method according to claim 3, wherein if there is no corrected phase difference of the m^{th}-level left and right eye images, the phase difference distribution estimation is performed respectively on the m^{th}-level left eye image feature and the m^{th}-level right eye image feature to obtain the m^{th}-level image phase difference distribution estimation feature.

6. The binocular image quick processing method according to claim 3, wherein if there is no corrected difference feature of the m^{th}-level left and right eye images, the m^{th}-level image phase difference distribution estimation feature and the m^{th}-level left eye image feature are fused to obtain the m^{th}-level fusion feature.

7. The binocular image quick processing method according to claim 3, wherien if there is no corrected phase difference of the m^{th}-level left and right eye images, the total estimated phase difference of the m^{th}-level left and right eye images is obtained based on an estimated phase difference of the m^{th}-level left and right eye images.

8. The binocular image quick processing method according to claim 3, wherein the step of obtaining the total estimated phase difference of the m^{th}-level left and right eye images based on an estimated phase difference of the m^{th}-level left and right eye images and the corrected phase difference of the m^{th}-level left and right eye images comprises:
optimizing the corrected phase difference of the m^{th}-level left and right eye images by using a preset activation function;
superimposing the optimized corrected phase difference of the m^{th}-level left and right eye images and the estimated phase difference of the m^{th}-level left and right eye images to obtain the total estimated phase difference of the m^{th}-level left and right eye images; and
optimizing the total estimated phase difference of the m^{th}-level left and right eye images by using the preset activation function.

9. A binocular image quick processing apparatus, comprising:
an image acquiring module, configured to acquire a first-level left eye image and a corresponding first-level right eye image;
a folding dimensionality reduction module, configured to perform folding dimensionality reduction operation on the first-level left eye image to acquire at least one next-level left eye image corresponding to the first-level left eye image, and perform the folding dimensionality reduction operation on the first-level right eye image to acquire at least one next-level right eye image corresponding to the first-level right eye image;
a first feature extraction module, configured to perform feature extraction on the next-level left eye image by using a first preset residual convolutional network to obtain a next-level left eye image feature, and perform the feature extraction on the next-level right eye image by using the first preset residual convolutional network to obtain a next-level right eye image feature;
a phase difference distribution estimation module, configured to perform phase difference distribution estimation on the next-level left eye image feature and the next-level right eye image feature to obtain a corresponding next-level image phase difference distribution estimation feature;
a fusing module, configured to fuse the next-level image phase difference distribution estimation feature with the next-level left eye image feature to obtain a next-level fusion feature;
a second feature extraction module, configured to perform feature extraction on the next-level fusion feature by using a second preset residual convolutional network to obtain a difference feature of next-level left and right eye images;
a next-level estimated phase difference acquiring module, configured to obtain an estimated phase difference of the next-level left and right eye images based on the difference feature of the next-level left and right eye images;
a tiling dimensionality raising module, configured to perform tiling dimensionality raising operation on the difference feature to obtain a corrected difference feature of first-level left and right eye images, and perform the tiling dimensionality raising operation on the estimated phase difference to obtain a corrected phase difference of the first-level left and right eye images;
a previous-level estimated phase difference acquiring module, configured to obtain an estimated phase difference of the first-level left and right eye images according to first-level left and right eye feature data, the corrected difference feature of the first-level left and right eye images, and the corrected phase difference of the first-level left and right eye images; and
an image processing module, configured to perform image processing operation on the corresponding images by using the estimated phase difference of the first-level left and right eye images.

10. The binocular image quick processing apparatus according to claim 9, wherein the next-level left eye image comprises an n^{th}-level left eye image, and the next-level right eye image comprises an n^{th}-level right eye image, wherein n is a positive integer greater than or equal to 1; and
the folding dimensionality reduction module comprises:
a left eye image folding dimensionality reduction unit, configured to perform the folding dimensionality reduction operation on the first-level left eye image to acquire the n^{th}-level left eye image corresponding to the first-level left eye image, wherein an image resolution of the n^{th}-level left eye image is 1/[4\hat{ }(n−1)] of an image resolution of the first-level left eye image; and
a right eye image folding dimensionality reduction unit, configured to perform the folding dimensionality reduction operation on the first-level right eye image to acquire the n^{th}-level right eye image corresponding to the first-level right eye image, wherein an image resolution of the n^{th}-level right eye image is 1/[4\hat{ }(n−1)] of an image resolution of the first-level right eye image.

11. The binocular image quick processing apparatus according to claim 9, further comprising:
a first feature extraction module, configured to perform feature extraction on an m^{th}-level left eye image by using the first preset residual convolutional network to obtain an m^{th}-level left eye image feature, and perform the feature extraction on an m^{th}-level right eye image by using the first preset residual convolutional network to obtain an m^{th}-level right eye image feature;
a phase difference distribution estimation module, configured to perform correction on the m^{th}-level right eye image by using a corrected phase difference of m^{th}-level left and right eye images, and perform the phase difference distribution estimation respectively on the m^{th}-level left eye image feature and a corrected m^{th}-level right eye image feature to obtain an m^{th}-level image phase difference distribution estimation feature;
a fusing module, configured to fuse the m^{th}-level image phase difference distribution estimation feature, the m^{th}-level left eye image feature and a corrected difference feature of the m^{th}-level left and right eye images to obtain an m^{th}-level fusion feature;
a second feature extraction module, configured to perform feature extraction on the m^{th}-level fusion feature by using the second preset residual convolutional network to obtain a difference feature of the m^{th}-level left and right eye images;
a next-level estimated phase difference acquiring module, configured to perform the phase difference distribution estimation on the m^{th}-level left and right eye images to obtain a current-level estimated phase difference of the m^{th}-level left and right eye images, and obtain a total estimated phase difference of the m^{th}-level left and right eye images based on the current-level estimated phase difference of the m^{th}-level left and right eye images and the corrected phase difference of the m^{th}-level left and right eye images;
a tiling dimensionality raising module, configured to perform the tiling dimensionality raising operation on the difference feature of the m^{th}-level left and right eye images to obtain a corrected difference feature of (m−1)^{th}-level left and right eye images, and perform the tiling dimensionality raising operation on the total estimated phase difference of the m^{th}-level left and right eye images to obtain a corrected phase difference of the (m−1)^{th}-level left and right eye images; and
a previous-level estimated phase difference acquiring module, configured to fuse, when m=1, the first-level left eye image, the first-level right eye image, a corrected difference feature of second-level left and right eye images and a corrected phase difference of the second-level left and right eye images to obtain a first-level fusion feature, and perform the phase difference distribution estimation on the first-level fusion feature to obtain the estimated phase difference of the first-level left and right eye images; and
a counting module, configured to perform counting operation on m.

12. The binocular image quick processing apparatus according to claim 11, wherein if there is no corrected phase difference of the m^{th}-level left and right eye images, the phase difference distribution estimation module performs the phase difference distribution estimation respectively on the m^{th}-level left eye image feature and the m^{th}-level right eye image feature to obtain the m^{th}-level image phase difference distribution estimation feature;
if there is no corrected difference feature of the m^{th}-level left and right eye images, the fusing module fuses the m^{th}-level image phase difference distribution estimation feature with the m^{th}-level left eye image feature to obtain the m^{th}-level fusion feature; and
if there is no corrected phase difference of the m^{th}-level left and right eye images, the next-level estimated phase difference acquiring module obtains the total estimated phase difference of the m^{th}-level left and right eye images based on an estimated phase difference of the m^{th}-level left and right eye images.

13. The binocular image quick processing apparatus according to claim 11, wherein the next-level estimated phase difference acquiring module is configured to optimize the corrected phase difference of the m^{th}-level left and right eye images by using a preset activation function; superimpose the optimized corrected phase difference of the m^{th}-level left and right eye images and the estimated phase difference of the m^{th}-level left and right eye images to obtain the total estimated phase difference of the m^{th}-level left and right eye images; and optimize the total estimated phase difference of the m^{th}-level left and right eye images by using the preset activation function.

14. A computer readable storage medium, wherein the computer readable storage medium stores at least one instruction, and the at least one instruction is executed by a processor in an electronic device, so as to implement the binocular image quick processing method of claim 1.
